(19) United States
(12) Patent Application Publication
(10) Pub. No.: US 2006/0215585 A1
(43) Pub. Date: Sep. 28, 2006

(54) Conference system, conference terminal, and mobile terminal

(75) Inventor: Yoshinori Taniwaki, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/358,221

(22) Filed: Feb. 22, 2006

(30) Foreign Application Priority Data
Feb. 28, 2005 (JP) 2005-053372

(51) Int. Cl. H04L 12/16

(52) U.S. Cl. 370/260

(57) ABSTRACT

A conference system for holding a conference by exchanging predetermined communication data including audio information among conference terminals located distributedly through a network. The conference system includes a mobile terminal including wireless communication means with another apparatus, audio input means for generating audio information from an input audio signal, audio reproducing means for reproducing sound based on the audio information obtained from the other apparatus, and connection-destination control means for selecting either a conference terminal or another mobile terminal as a communication destination by a user's setting and controlling to exchange the audio information with the selected communication destination; and a conference terminal including wireless communication means with the mobile terminal, network communication means for controlling mutual communication with the conference terminal connected through the network, authentication means for authenticating the mobile terminal, and relay processing means for relaying the audio information to the mobile terminal.

### CROSS REFERENCES TO RELATED APPLICATIONS

The present invention contains subject matter related to Japanese Patent Application JP 2005-053372 filed in the Japanese Patent Office on Feb. 28, 2005, the entire contents of which are incorporated herein by reference.

### BACKGROUND OF THE INVENTION

1. Field of the Invention

The present invention relates to a conference system, a conference terminal apparatus, and a mobile terminal apparatus. More particularly, the present invention relates to a conference system, a conference terminal apparatus thereof, and a mobile terminal apparatus, for holding a conference by exchanging predetermined communication data including audio information among conference terminal apparatuses distributedly located through a network.

2. Description of the Related Art

To date, two-way communication apparatuses, such as television conference terminals and IP (Internet Protocol) telephone terminals, have been introduced in office environments. Each of the apparatuses has a communication function of audio and video information, and is capable of providing services such as telephone conversation on an IP network or a television telephone (conference).

However, in a telephone conference system using known telephone conference terminals, when a user is absent, that is to say, when a user is not at the place where the user can use a telephone conference terminal, that user is not allowed to participate in a telephone conference. At the same time, the user is not allowed to know that the telephone conference is being held. Accordingly, when a telephone conference is started, the users are not allowed to be away from their telephone conference terminals.

In order to cope with this, when a user of a telephone conference terminal is absent and is not allowed to respond to a received call, a system which transfers a received call of a telephone conference terminal to a mobile terminal apparatus carried with the user has been proposed (for example, Japanese Unexamined Patent Application Publication No. 2002-335502, (Paragraph Numbers [0077] to [0088], FIG. 3).

### SUMMARY OF THE INVENTION

However, there has been a problem in that in a know conference system, a scheme of providing services by the coordination of individual apparatuses connected to a network has not been built.

To date, even among two-way communication apparatuses connected to a common network, exchanging data have been possible only between apparatuses that belong to the same system. For example, suppose that a telephone conference system including telephone conference terminals and a telephone system including IP telephone terminals are operating with communication, respectively, on a common IP network. In this case, a telephone conference terminal that belongs to the telephone conference system and an IP telephone terminal that belongs to the telephone system are not allowed to directly exchange data. Accordingly, if a member who is participating in a meeting using telephone conference terminals leaves during the conference temporarily, that member is not allowed to use the telephone conference terminal. Thus, the member is not allowed to know the progress of that meeting during the absence. If the member needs to contact another member at any cost, another member participating in the telephone conference acts as a go-between through the IP telephone terminal held by that member. As described above, in a known conference system, there has been a problem in that a scheme of providing services in coordination with individual apparatuses connected to a network has not been built, and thus the conference system has been poor in user-friendliness.

In this regard, the above-described system that transfers a received call of a telephone conference terminal to a mobile terminal apparatus is a system produced by adding a mobile terminal apparatus to a telephone conference system. The mobile terminal apparatus functions only as a data-transfer destination of a telephone conference terminal. Also, there is a problem in that the terminal does not function as a telephone conference terminal during the data transfer.

The present invention has been made in view of these problems. It is desirable to provide a conference system, a conference terminal apparatus, and a mobile terminal apparatus capable of providing services in coordination with two-way communication apparatuses.

According to the present invention, there is provided a conference system for holding a conference by exchanging predetermined communication data including audio information among conference terminal apparatuses located distributedly through a network. The mobile terminal apparatus includes wireless communication means for controlling wireless communication with another apparatus, audio input means for generating audio information from an input audio signal, audio reproducing means for reproducing sound based on the audio information obtained from another apparatus through the wireless communication means, and connection-destination control means for selecting either the conference terminal apparatus or another mobile terminal apparatus as the communication destination in accordance with a user's setting and controlling to exchange the audio information between the selected communication destination. On the other hand, the conference terminal apparatus includes wireless communication means for controlling wireless communication with the mobile terminal apparatus, network communication means for controlling mutual communication of the audio information with the other conference terminal apparatus connected through the network, authentication means for authenticating the mobile terminal apparatus connected by the wireless communication means, and relay processing means for relaying the audio information to the mobile terminal apparatus when selected as a communication destination of the mobile terminal apparatus in accordance with the user's setting obtained from the mobile terminal apparatus authenticated by the authentication means. While the conference terminal performs a conference processing function, if selected as a communication destination of the mobile terminal apparatus, the conference terminal performs relay processing for relaying audio information to the mobile terminal.

The conference system having such a configuration makes it possible for a conference terminal apparatus located distributedly and a mobile terminal apparatus possessed by a user to mutually communicate through wireless communication means as necessary. Also, the conference terminal apparatus connects to another conference terminal apparatus through the network communication means, exchanges data of conference information such as audio information, video information, etc., and achieves a conference among a plurality of locations. Also, the mobile terminal apparatus exchanges data with another mobile terminal apparatus to achieve telephone conversation between two points. Also, when the mobile terminal apparatus requests a connection to the conference terminal apparatus through the wireless communication means, the authentication means of the conference terminal apparatus determines whether or not the mobile terminal apparatus is authenticated. If authenticated, the connection request of the mobile terminal apparatus is permitted, and the subsequent communication becomes possible. The connection-destination control means of the mobile terminal apparatus selects a communication destination of the audio information in accordance with the setting of the user, transmits the audio information generated by the audio input means to this communication destination, and, at the same time, sends the audio information obtained from the communication destination to the audio reproduction means to reproduce the audio information. On the other hand, when the conference terminal apparatus itself is selected as the communication destination, the relay processing means of the conference terminal apparatus relays the audio information being data-exchanged with another conference terminal apparatus to the mobile terminal apparatus. That is to say, if another mobile terminal apparatus is selected as a communication destination by the mobile terminal apparatus, telephone conversation between the mobile terminal apparatuses is performed. Also, for example, if the conference terminal apparatus that has performed authentication is selected as a communication destination, the audio information based on the audio signal input by the mobile terminal apparatus is transmitted to the conference terminal apparatus, and furthermore, is transmitted to another conference terminal apparatus to be reproduced there. Also, the audio information obtained by the conference terminal apparatus from another conference terminal apparatus is transmitted to the mobile terminal apparatus. The mobile terminal apparatus relays the contents of the conference to the mobile terminal apparatus by reproducing the sound on the basis of the audio information.

In a conference system according to the present invention, when a mobile terminal apparatus requests a connection through wireless communication and is authenticated by a conference terminal apparatus, the mobile terminal apparatus can select the conference terminal apparatus as the communication destination for exchanging data. When the conference terminal apparatus is selected, the audio information exchanged between the conference terminal apparatuses is relayed to the mobile terminal apparatus through the selected conference terminal apparatus. Thus, it becomes possible for the two-way communication apparatuses, namely, the conference terminal apparatus and the mobile terminal apparatus to provide services in coordination with each other. It is possible to easily change a service mode from a mode of providing telephone conversation between the mobile terminal apparatuses to a mode of allowing participation in a conference among conference terminal apparatuses using the mobile terminal apparatus, or vice versa in accordance with the situation. As a result, for example, even if a user leaves his or her seat, the user can keep participating in the conference using the mobile terminal apparatus, and thus the user-friendliness of the two-way communication apparatuses is improved.

### BRIEF DESCRIPTION OF THE DRAWINGS

FIG. 1 is a schematic diagram of the invention applied to an embodiment;

FIG. 2 is a configuration diagram of a television conference system according to the embodiment of the present invention;

FIG. 3 is a block diagram illustrating an example of a hardware configuration of a mobile terminal according to the present embodiment;

FIG. 4 is a sequence chart illustrating the operation when entering a relay state in a conference system according to the present embodiment; and

FIG. 5 is a sequence chart illustrating the operation when the relay state terminates in a conference system according to the present embodiment.

### DESCRIPTION OF THE PREFERRED EMBODIMENTS

In the following, a description will be given of an embodiment of present invention with reference to the drawings. First, a description will be given of a concept of the invention to be applied to the embodiment. Next, a description will be given of specific contents of the embodiment.

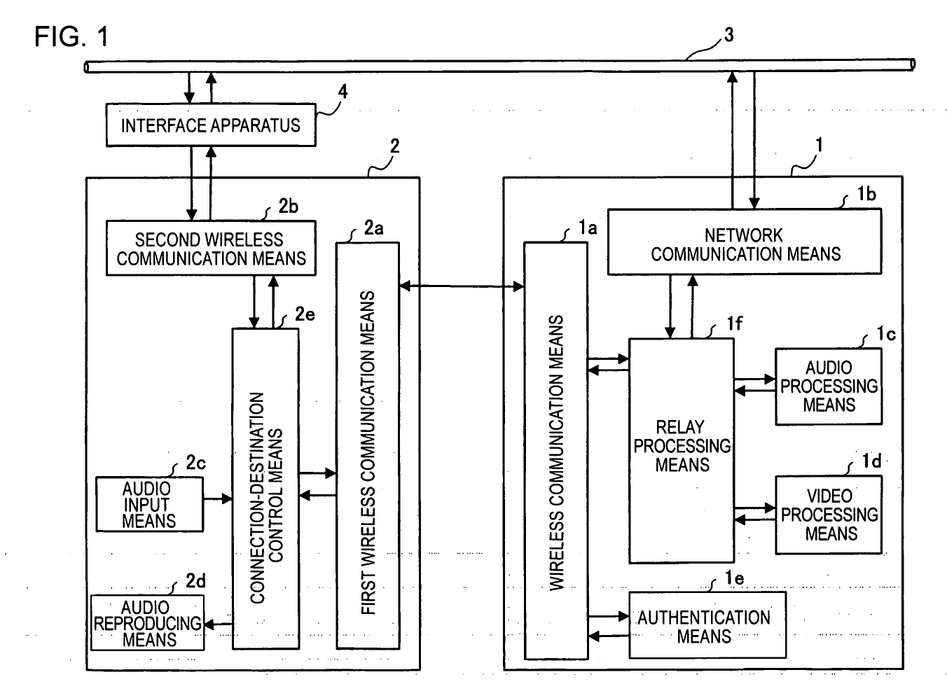

FIG. 1 is a schematic diagram of the invention applied to the embodiment.

A conference system according to the present invention has a conference terminal apparatus (called a conference terminal in the following) 1, and a mobile terminal apparatus (called a mobile terminal in the following) 2 possessed by a user. The conference terminal 1 includes wireless communication means la for controlling the communication with the mobile terminal 2, network communication means 1b for controlling the communication with another apparatus connected to a network 3 through the network 3, audio processing means 1c for performing audio processing, such as audio recording, audio reproduction, etc., video processing means id for performing video processing, such as image pick-up, video reproduction, etc., authentication means 1e for authenticating the mobile terminal 2, and relay processing means if for relaying audio information to the mobile terminal 2 in accordance with the setting by the user. The conference terminal 1 performs mutual communication with a conference terminal located another point through the network 3. On the other hand, the mobile terminal 2 includes first wireless communication means 2a for controlling the communication with the conference terminal 1, second wireless communication means 2b for controlling the communication with an interface apparatus 4, audio input means 2c for receiving audio input, audio reproducing means 2d for audio reproduction, and connection-destination control means 2e for selecting a communication destination of the audio information and controlling data transmission and receiving.

First, a description will be given of each processing unit of the conference terminal 1.

The wireless communication means la controls data exchange with the mobile terminal 2 by wireless communication. The wireless communication means 1a performs vicinity communication capable of the communication only with a mobile terminal 2 located within a predetermined range of vicinity from the conference terminal 1. In this regard, for vicinity communication, for example, Feilica (a registered trade mark) or NFC (Near Field Communication) is used. These vicinity communications achieve communications within the of vicinity of apparatuses having a distance of about 10 cm with each other.

The network communication means 1b controls communication with another apparatus connected through the network 3. Another apparatus includes another conference terminal, a mobile terminal 2 connected through the interface apparatus 4, a control server (not shown) for controlling the entire conference system, and the like.

The audio processing means 1c includes an audio input unit, such as a microphone, etc., an audio output unit, such as a speaker, etc., an audio integration unit, and performs audio-information generation and audio reproduction. When the audio input unit generates audio information from the voices of surrounding people input by a microphone, etc., the audio integration unit combines the audio information obtained from the conference terminal 1 itself and the audio information of another apparatus. The audio output unit reproduces and outputs the sound on the basis of the audio information generated by the audio integration unit.

The video processing means id includes an image pickup unit such as a camera, etc., a video reproduction unit, etc., including a monitor, a video processing unit, etc., and performs image pickup information generation and video reproduction. The image pickup unit generates video information from a video signal picked up by a camera, etc. The video processing unit reproduces the video signal reconstructed from the video information obtained from another apparatus or the video information of that apparatus itself, and displays the image based on the video signal.

The authentication means 1e performs authentication of the mobile terminal 2 to determine whether or not to allow connection against a connection request of the mobile terminal 2 input through the wireless communication means 1a, and transmits the determination result to the mobile terminal 2 through the wireless communication means 1a. The authentication is performed, for example by obtaining the apparatus-specific information from the mobile terminal 2 and determining whether or not to authenticate the apparatus on the basis of this information. If authenticated, authentication means 1e notifies the network address of that conference terminal 1 itself together with the notification of authentication. Also, the authentication means 1e obtains the network address of the mobile terminal 2 as necessary.

When the relay processing means if is notified that the conference terminal 1 itself is selected as a communication destination from the mobile terminal 2 via the wireless communication means 1a, the relay processing means if starts relay processing of the audio and video information being exchanged among conference terminals. The relay processing transmits the audio information produced by combining the audio information obtained from another conference terminal and the audio information based on the audio signal recorded by that terminal itself to the mobile terminal 2 through the wireless communication means 1a and the network communication means 1b. Also, the relay processing combines the audio information obtained from the mobile terminal 2 through the same path and the audio information based on the audio signal recorded by that terminal itself, and transmits the audio information to another conference terminal through the network communication means 1b. In this regard, when the mobile terminal 2 does not select the conference terminal 1 itself as the communication destination, the relay processing means 1f does not perform the relay processing to the mobile terminal 2, adds the information of that terminal itself to the audio and video information obtained from another conference terminal to transmits the information to another conference terminal, and reproduces audio and video on the basis of the audio and video information.

Next, a description will be given of each processing unit of the mobile terminal 2.

The first wireless communication means 2a controls the vicinity communication performed between the conference terminal 1 and the wireless communication means 1a.

The second wireless communication means 2b controls communication with the interface apparatus 4 connected to the network 3. The second wireless communication means 2b is capable of performing wireless communication in a range wider than the first wireless communication means 2a, and enables the mobile terminal 2 to be used as a mobile telephone using the network.

The audio input means 2c generates audio information from the audio signal of the user entered through a microphone, etc.

The audio reproducing means 2d reproduces the sound based on the audio information obtained through the connection-destination control means 2e, and outputs the sound.

The connection-destination control means 2e selects whether to set the communication destination of the audio information to another mobile terminal or to the conference terminal 1. Next, the connection-destination control means 2e controls exchanging data of the audio information with the selected communication destination. If another terminal is selected as the communication destination, a connection is made to the interface apparatus 4 through the second wireless communication means 2b, and a connection is made to the network 3 through the interface apparatus 4. Thus, the audio information generated by the audio input means 2c of the mobile terminal 2 is transmitted to another mobile terminal, and is reproduced by the audio reproduction means. Also, the audio information generated by the audio input means of another mobile terminal is received, and is reproduced by the audio reproducing means 2d. That is to say, the mobile terminal functions as a mobile telephone connected to the network 3, and enables telephone conversation between the mobile terminals. On the other hand, if the conference terminal 1 is selected as the communication destination, a connection is established to the interface apparatus 4 through the first wireless communication means 2a or the second wireless communication means 2b, and a connection is established to the conference terminal 1 through the network 3 to perform mutual communication of the audio information. Thus, the audio information generated by the conference terminal 1 is input into the mobile terminal 2, and is reproduced by the audio reproducing means 2d. Also, the audio information generated by the audio input means 2c of the mobile terminal 2 is transmitted to the conference terminal 1, is subjected to audio integration, and then is transmitted to the other conference terminals. That is to say, the mobile terminal 2 can participate in the conference through the conference terminal 1.

In this regard, each processing unit of the conference terminal 1 and the mobile terminal 2 described above are achieved by computers executing programs.

A description will be given of the operation of the conference system having the above configuration. In the following description, a state in which another mobile terminal is selected as a communication destination of the mobile terminal 2 to allow a function of a mobile telephone is called a normal state. Also, a state in which conference terminal 1 is selected as a communication destination of the mobile terminal 2 to relay a conference is called a relay state.

First, a description will be given of the operation in the normal state.

In the normal state, the conference terminal 1 is instructed to start a conference, the conference terminal 1 starts mutual communication of the audio and video information for the conference with the conference terminal of the other party located at another point through the network 3. When the relay processing means if receives audio and video information from another conference terminal through the network communication means 1b, since the current state is the normal state, the relay processing means 1f sends the audio information and the video information to the audio processing means 1c and the video processing means 1d, respectively. The audio processing means 1c reproduces and outputs the sound on the basis of the audio information produced by the combination of the obtained audio information and the audio information based on the audio signal recorded by the terminal itself. Similarly, the video processing means 1d reorganizes the obtained video information and the video information captured by the terminal itself in accordance with the specified manner. Also, the audio information and the video information are transmitted to the conference terminal of the other party through the network communication means 1b in accordance with the relay processing means if. Thus, the conference terminal 1 and the conference terminal of the other party reproduce the audio and the specified video such as the face of the other party, etc., with each other. The conference is held in this manner.

On the other hand, the conference terminal 2 mutually communicate audio information with another conference terminal located at another point through the second interface apparatus 4 connected to the network 3. The audio information generated by the audio input means 2c is transmitted to another mobile terminal through the second wireless communication means 2b and the interface apparatus 4, and is reproduced by the audio reproducing means of that mobile terminal. On the contrary, the audio information to the other party is reproduced by the audio reproducing means 2d of the mobile terminal 2, and thus telephone conversation between two mobile terminals is achieved.

Next, a description will be given of the case of changing into a relay state during a conference among conference terminals.

For example, when a user needs to leave during a conference, but wants to continue participating in the conference, the user places the mobile terminal 2 in the vicinity of the conference terminal 1 to request a connection, the mobile terminal 2 transmits a connection request through the first wireless communication means 2a. When the conference terminal 1 receives input of the connection request from the wireless communication means 1a, the conference terminal 1 performs the authentication of the mobile terminal 2 by the authentication means 1e. If authenticated, the connection is permitted, and the network address of the conference terminal 1 is notified. When the mobile terminal 2 obtains a network address through the first wireless communication means 2a, the mobile terminal 2 changes the operation state to the relay state in accordance with the instruction of the user by a predetermined button operation, etc., and sets the communication destination selected by the connection-destination control means 2e in the conference terminal 1. At the same time, the change to the relay state is also notified to the conference terminal 1 through the first wireless communication means 2a and the wireless communication means 1a, and the relay processing means 1f changes the operation state to the relay state.

When both the mobile terminal 2 and the conference terminal 1 enters the relay state, the mobile terminal 2 transmits the audio information generated by the audio input means 2c to the conference terminal 1 by the connection-destination control means 2e through the second wireless communication means 2b, and reproduces the audio information of the conference terminal 1 obtained through the opposite path by the audio reproducing means 2d. In this regard, the reason for using the second wireless communication means 2b here is to allow the user to freely move around. The conference terminal 1 combines the audio information obtained from another terminal, the audio information detected by the terminal itself, and the audio information obtained from the mobile terminal 2, reproduces the information, and transmits the information to another terminal. In some conference systems, the audio information produced only by combining the audio information detected by the terminal itself and the audio information obtained by the mobile terminal 2 is sometimes transmitted to another conference terminal. When audio information is obtained from another conference terminal, the conference terminal combines this audio information and the audio information detected the terminal itself, and transmits the information to the mobile terminal 2. Thus, the mobile terminal 2 obtains the same audio information as that of the conference terminal 1, and can reproduce the information by the audio reproducing means 2d. Also, the audio information input into the terminal itself can be transmitted to another conference terminal through the conference terminal 1. That is to say, the mobile terminal 2 functions as a mobile conference terminal, and it becomes possible for a user leaving from the conference to continue to participate in that conference.

In the above, a description has been given of the case where a participant in a conference leaves during the conference. However, the change to the relay state can also be applied to the case of allowing another member to participate in a conference being held.

Also, when the user operates a predetermined button of the mobile terminal 2, the user notifies the instruction for returning from the relay state to the normal state to the mobile terminal 2. Thus, the connection-destination control means 2e deletes the conference terminal 1 from the connection destination, and returns the operation state to the normal state. Similarly, the release of the relay state is also notified to the conference terminal 1, and the relay processing means 1f returns the operation state to the normal state. After both terminals have returned to the normal state, the conference terminal 1 terminates the relay processing to the mobile terminal 2, and returns to a conference state among the other conference terminals.

In this regard, in the above description, a description has been given of the case where the mobile terminal 2 handles only audio information. However, when the mobile terminal 2 is provided with a video processing function, it is possible to transmit and receive video information together with audio information. In the relay state, the video reproducing means for reproducing video in a mobile terminal displays images based on the video information relayed by the conference terminal 1. Also, it is possible to display images based on the video information of the terminal itself to another conference terminal by relaying the video information captured by itself by the image-pickup means to another conference terminal through the conference terminal 1. In this regard, the mobile terminal 2 may be provided with both the video reproducing means and the capturing means, or may be provided with only either one of them.

As described above, in two-way communication apparatuses for providing services of a conference terminal constituting a conference system and a mobile terminal constituting a mobile telephone system, respectively, in the normal state, if the user places the mobile terminal near the conference terminal and issues an instruction to enter the relay state, it becomes possible for the conference terminal and the mobile terminal to provide one service in coordination with each other. As a result, user-friendliness of the two-way communication apparatuses is improved, for example, even if a user leaves, that user can participate in the conference using the mobile terminal.

Also, the change from the normal state to the relay state or the change of the other way around can be carried out easily by the operation of a predetermined mobile terminal or the like. In this manner, it is not necessary to perform complicated setting processing at change time. The operation can be changed easily.

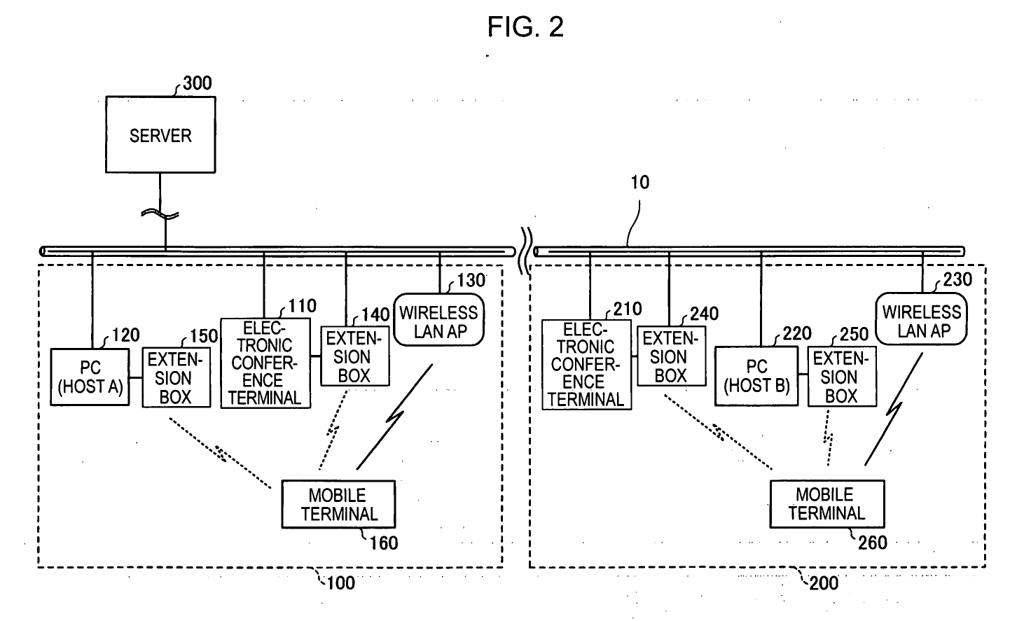

In the following, a detailed description will be given of the case where the embodiment is applied to a telephone conference system with reference to the drawings. FIG. 2 is a configuration diagram of a telephone conference system according to the embodiment of the present invention.

In the telephone conference system of the embodiment, electronic conferencing terminals 110 and 210, which are conference terminals, and mobile terminals (in the following, called controllers) 160 and 260, PCs 120 and 220, which are file terminals, are connected to a server 300, which is a conference administrating apparatus, through an IP network line (in the following, called an IP network) 10. In this regard, the electronic conferencing terminal 110 and the PC 120 are located in a conference room A (100), and the electronic conferencing terminal 210 and the PC 220 are distributedly located in a conference room B (200).

Here, extension BOXes 140 and 240 connected to the electronic conferencing terminals 110 and 210 control the vicinity communication between the electronic conferencing terminals 110 and 210 and the controllers 160 and 260, and control the operation of the electronic conferencing terminals 110 and 210. Similarly, extension BOXes 150 and 250 connected to the PCs 120 and 220 control the vicinity communication between the PCs 120 and 220 and the controller 160 and 260, and control the operation of the PCs 120 and 220. In this regard, apparatuses, such as the extension BOXes 140, 150, 240, and 250, the electronic conferencing terminals 110 and 210, and the PCs 120 and 220, etc., may be formed by an all-in-one unit.

Also, wireless LANAPs (130 and 230) perform wireless communication with the controllers 160 and 260 in order for the controllers 160 and 260 to directly communicate with another apparatus connected to the IP network 10.

In this regard, the PCs 120 and 220 are file terminals, and stores a common file to be referenced during a conference, etc. Also, the server 300 controls the entire conference system and performs monitoring. Since the PCs 120 and 220 and the server 300 are not directly related to the present invention, further descriptions thereof will be omitted.

The controllers 160 and 260 connect the electronic conferencing terminals 110 and 210 through the extension BOXes 140 and 240, performs authentication, and can give instruction information to change from the normal state to the relay state, or the change of the other way around, etc.

Also, the controllers 160 and 260 can communicate with the electronic conferencing terminals 110 and 210 and another mobile terminal using the wireless LANAPs (130 and 230) through the IP network 10. For example, in the normal state, the controller 160 can exchange audio information with the controller 260 connected to the wireless LANAPs 230 through the wireless LANAP 130, and to carry out telephone conversation. In the relay state, the controller 160 can obtain audio and video information for a conference exchanged between the electronic conferencing terminals 110 and 210 through the IP network 10 by relaying the information through the electronic conferencing terminals 110 and 210.

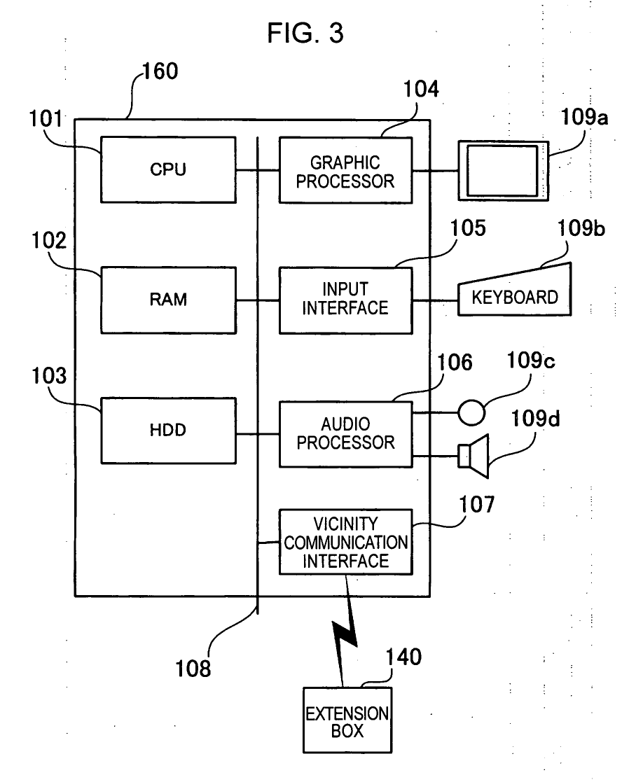

Here, a description will be given of the hardware configuration of the controller 160. In this regard, the controller 260 has the same configuration. FIG. 3 is a block diagram illustrating an example of a hardware configuration of a mobile terminal according to the present embodiment.

The entire unit of the controller 160 is controlled by a CPU (Central Processing Unit) 101. The CPU 101 is connected via the bus 108 to a RAM (Random Access Memory) 102, an HDD (hard disk drive) 103, a graphic processor 104, an input interface 105, an audio processor 106, and a vicinity communication interface 107.

The RAM 102 temporarily stores at least a part of an OS (Operating System) program and application programs to be executed by the CPU 101. Also, the RAM 102 stores various data necessary for the processing by the CPU 101. The HDD 103 stores the OS and application programs. The graphic processor 104 is connected to a monitor 109a, and displays images on a monitor 109a in accordance with instructions from the CPU 101. The input interface 105 is connected to a keyboard 109b, and transmits the signal sent from the keyboard 109b to the CPU 101 through the bus 108. The audio processor 106 is connected to a microphone 109c and a speaker 109d, transmits the audio signal input from the microphone 109c to the CPU 101 through the bus 108, and outputs the sound to the speaker 109d in accordance with the CPU 101. The vicinity communication interface 107 transmits and receives data to and from the extension BOX 140, etc., using vicinity communication.

With such a hardware configuration, it is possible to achieve the processing functions of the present embodiment. In this regard, FIG. 3 illustrates the hardware configuration of the mobile terminal. The conference terminal has the same hardware configuration.

Next, a description will be given of the operation of each unit of the conference system having such a configuration.

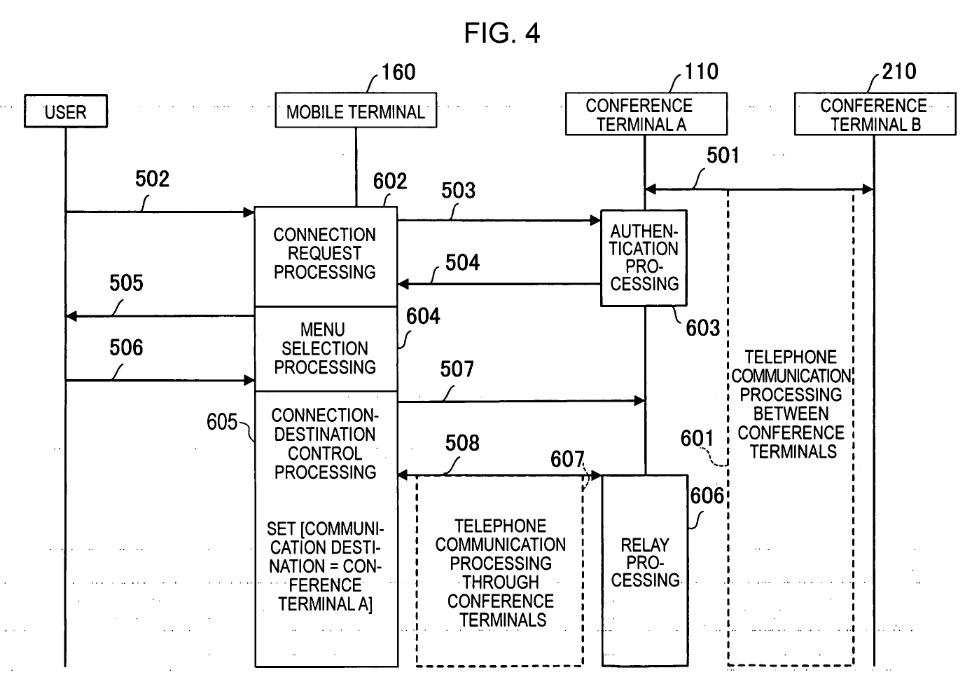

First, a description will be given of the change operation from the normal state to the relay state. FIG. 4 is a sequence chart illustrating the operation when entering a relay state in a conference system according to the present embodiment. The same parts as those in FIG. 2 are marked with the same reference numerals, and the descriptions thereof are omitted. In this regard, in the following, in order to make a distinction, the electronic conferencing terminal 110 is called a conference terminal A (110), and the electronic conferencing terminal 120 is called a conference terminal B (120).

In the normal state, the controller 160 mutually exchanges audio information with another mobile terminal through the IP network 10 as necessary, and can function as an IP telephone. Also, a telephone conference can be held between the conference terminal A (110) and the conference terminal B (120) by mutually exchanging audio and video information through the IP network 10.

In a conference between the conference terminal A (110) and the conference terminal B (210), telephone conversation processing 601 is started when an instruction to start telephone conversation 501 is issued to both of the terminals, and thus telephone conversation between the terminals becomes possible. While the telephone conversation processing 601 between the conference terminals is carried out, the audio and video information generated by the conference terminal A (110) is transmitted to the conference terminal B (210) to be reproduced, and the audio and video information generated by the conference terminal B (210) is transmitted to the conference terminal A (110) to be reproduced.

The change from this state to the relay state is started when a user of the controller 160 performs vicinity communication for authentication by placing the controller 160 near the conference terminal A (110). First, when the user places the controller 160 in the vicinity of the conference terminal A (110) and issues a connection instruction 502 to the controller 160 by a button operation, etc., the controller 160 starts connection request processing 602, and transmits a connection request 503 to the conference terminal A (110) through the vicinity communication. At this time, the specific information, the IP address, etc., of the controller 160, are transmitted for authentication. When the conference terminal A (110) receives the connection request 503, the conference terminal A (110) starts authentication processing 603, authenticates the controller 160 by the obtained information, and returns the authentication result. Here, suppose that the controller 160 has been authenticated, an authentication response 504 indicating the completion of the authentication is assumed to be returned. At this time, the conference terminal A (110) transmits an operation menu to be displayed to the controller 160 to the controller 160 together with the IP address of the conference terminal A (110), etc.

When the controller 160 obtains the IP address and the operation menu together with the authentication response 504, the controller 160 starts menu selection processing 604. The controller 160 displays the operation menu screen 505 obtained from the conference terminal A (110) to a display unit as a menu selectable by the user. By obtaining an operation menu from the conference terminal A (110), it is possible to easily display a menu corresponding to each of the connected apparatuses. The apparatuses that can be connected by the vicinity communication includes a file terminal, etc., in addition, and thus it is not necessary for the controller 160 to maintain corresponding menus and to perform complicated processing for selectively displaying a menu. The user performs a menu selection 506 of the change to the relay state by operating a button to instruct to the change to the relay state from the displayed menu. The controller 160 sets the communication destination information to be referenced by the connection-destination control processing 605 in the [communication destination=conference terminal A] in accordance with the change to the relay state. The controller 160 starts calling 507 using the obtained IP address of the conference terminal A (110), and executes the procedure for establishing the communication to connect to the conference terminal A (110) via the IP network 10 through the wireless LANAP 130. When a call is setup between the controller 160 and the conference terminal A (110), the communication by the setup of a call is started 508, and the conference terminal A (110) starts relay processing 606.

Thus, communication processing 607 between the controller 160 and the conference terminal A (110) is performed by the relay of the conference terminal A (110) via the conference terminals. At this time, the telephone conversation processing 601 between the conference terminals is continued to be carried out between the conference terminal A (110) and the conference terminal B (210). That is to say, the audio information of the conference terminal A (110) is added to the audio information sent from the conference terminal B (210) at the conference terminal A (110), and the audio information is sent to the controller 160. At the same time, the audio information of the conference terminal A (110) is added to the audio information of the controller 160 at the conference terminal A (110), and is sent to the conference terminal B (210).

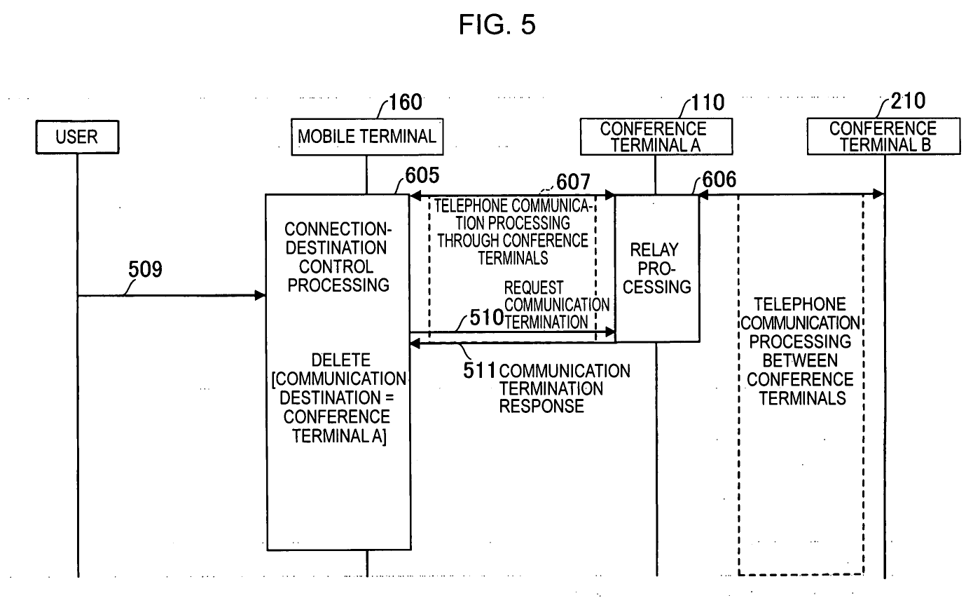

Next, a description will be given of the operation of the change from the relay state to the normal state. FIG. 5 is a sequence chart illustrating the operation when the relay state terminates in a conference system according to the present embodiment.

The operation state becomes the relay state as shown in FIG. 4, telephone conversation processing is performed between the controller 160 at the conference terminal A (110) through the conference terminals, and the telephone conversation processing between the conference terminals is carried out between the conference terminal A (110) and the conference terminal B (210).

In this state, the user performs menu selection 509 to instruct the termination of the relay state to the controller 160 by the operation of a button, etc. Thus, the controller 160 transmits a communication termination request 510 of the relay processing to the conference terminal A (110). When the conference terminal A (110) receives the communication termination request 510, the conference terminal A (110) terminates the relay processing 606, and terminates the communication processing 607 carried out with the controller 160 via conference terminals. At the same time, the conference terminal A (110) transmits a communication termination response 511 to the controller 160. The controller 160 deletes the [communication destination=conference terminal A] information by the communication termination response 511.

Thus, the operation state is changed from the relay state to the normal state, the telephone conversation processing 601 between the conference terminals is carried out between the conference terminal A (110) and the conference terminal B (210), and it is possible to hold a telephone conference by mutually exchanging audio information and video information for a conference through the IP network 10.

It should be understood by those skilled in the art that various modifications, combinations, sub-combinations and alterations may occur depending on design requirements and other factors insofar as they are within the scope of the appended claims or the equivalents thereof.

What is claimed is:

1. A conference system for holding a conference by exchanging predetermined communication data including audio information among conference terminal apparatuses located distributedly through a network, the conference system comprising:
a mobile terminal apparatus including wireless communication means for controlling wireless communication with another apparatus, audio input means for generating audio information from an input audio signal, audio reproducing means for reproducing sound based on the audio information obtained from another apparatus through the wireless communication means, and connection-destination control means for selecting either the conference terminal apparatus or another mobile terminal apparatus as a communication destination in accordance with a user's setting and controlling to exchange the audio information between the selected communication destination; and
a conference terminal apparatus including wireless communication means for controlling wireless communication with the mobile terminal apparatus, network communication means for controlling mutual communication of the audio information with the other conference terminal apparatus connected through the network, authentication means for authenticating the mobile terminal apparatus connected by the wireless communication means, and relay processing means for relaying the audio information to the mobile terminal apparatus when selected as the communication destination of the mobile terminal apparatus in accordance with the user's setting obtained from the mobile terminal apparatus authenticated by the authentication means.

2. The conference system according to claim 1,
wherein the wireless communication means of the mobile terminal apparatus includes:
first communication means capable of communicating only in a predetermined range of vicinity of the conference terminal apparatus and for use in communicating with the conference terminal apparatus; and
second communication means used for communication with an interface apparatus relaying communication with another apparatus connected to the network,
wherein authentication of the mobile terminal apparatus is carried out by the first wireless communication means.

3. The conference system according to claim 2,
wherein when the authentication means of the conference terminal apparatus authenticates the mobile terminal apparatus, the authentication means notifies a network address of the conference terminal apparatus to the mobile terminal apparatus, and
when the conference terminal apparatus is selected as the communication destination, the connection-destination control means of the mobile terminal apparatus communicate with the conference terminal apparatus through the network using the second wireless communication means.

4. The conference system according to claim 1,
wherein the mobile terminal apparatus further includes video reproducing means for reproducing video on the basis of video information obtained from another apparatus and imaging means for generating the video information from an image-pickup signal as necessary, and
the relay processing means of the conference terminal apparatus relays the video information together with the audio information.

5. The conference system according to claim 1,
wherein the relay processing means of the conference terminal apparatus combines the audio information generated on the basis of an input audio signal of the mobile terminal apparatus obtained from the mobile terminal apparatus with audio information based on input audio information of the conference terminal apparatus itself to transmit the audio information to another conference terminal apparatus, and at the same time, combines the audio information obtained from the other conference terminal apparatus with the audio information based on an input audio signal of the conference terminal apparatus itself to transmit the audio information to the mobile terminal apparatus.

6. The conference system according to claim 1,
wherein the authentication means of the conference terminal apparatus transmits an operation menu information settable by the user including relaying a conference by the conference terminal apparatus to a connection request of the mobile terminal apparatus, and
the connection-destination control means of the mobile terminal apparatus presents the operation menu information to the user, and selects the conference terminal apparatus as the communication destination if the relaying a conference is selected.

7. A conference terminal apparatus located distributedly through a network for holding a conference by exchanging predetermined communication data including audio information, the conference terminal apparatus comprising:
wireless communication means for controlling wireless communication with a mobile terminal apparatus mutually exchanging audio information for telephone conversation through the network,
network communication means for controlling mutual communication of the audio information generated by the conference terminal apparatus with another conference terminal apparatus connected through the network,
authentication means for authenticating the mobile terminal apparatus connected by the wireless communication means, and
relay processing means for relaying the audio information to the mobile terminal apparatus when selected as a communication destination of the mobile terminal apparatus in accordance with the user's setting obtained from the mobile terminal apparatus authenticated by the authentication means.

8. A mobile terminal apparatus for carrying out telephone communication by mutually exchanging audio information for telephone conversation through the same network as a conference terminal apparatus for holding a conference by exchanging predetermined communication data including audio information among conference terminal apparatuses located distributedly through a network, the mobile terminal apparatus comprising:
wireless communication means for controlling wireless communication with another apparatus;
audio input means for generating audio information from input audio signal;
audio reproducing means for reproducing sound based on the audio information obtained from another apparatus through the wireless communication means or the audio information for telephone communication, and connection-destination control means for selecting either the conference terminal apparatus or another mobile terminal apparatus as a communication destination in accordance with a user's setting and controlling to exchange the audio information or the audio information for telephone communication with the selected communication destination,
wherein when the conference terminal apparatus is selected as the communication destination, the audio information held by the conference terminal apparatus and relayed from the conference terminal is reproduced by the audio reproducing means.

9. A conference system for holding a conference by exchanging predetermined communication data including audio information among conference terminal apparatuses located distributedly through a network, the conference system comprising:
a mobile terminal apparatus including a wireless communication mechanism for controlling wireless communication with another apparatus, an audio input mechanism for generating audio information from an input audio signal, an audio reproducing mechanism for reproducing sound based on the audio information obtained from another apparatus through the wireless communication mechanism, and a connection-destination controller for selecting either the conference terminal apparatus or another mobile terminal apparatus as a communication destination in accordance with a user's setting and controlling to exchange the audio information between the selected communication destination; and
a conference terminal apparatus including a wireless communication mechanism for controlling wireless communication with the mobile terminal apparatus, a network communication mechanism for controlling mutual communication of the audio information with the other conference terminal apparatus connected through the network, an authentication mechanism for authenticating the mobile terminal apparatus connected by the wireless communication mechanism, and a relay processing mechanism for relaying the audio information to the mobile terminal apparatus when selected as the communication destination of the mobile terminal apparatus in accordance with the user's setting obtained from the mobile terminal apparatus authenticated by the authentication mechanism.
